(19) United States
(12) Patent Application Publication
(10) Pub. No.: US 2007/0150726 A1
(43) Pub. Date: Jun. 28, 2007

(54) System and method for securely storing and accessing credentials and certificates for secure VoIP endpoints

(76) Inventors: Heinrich Sinnreich, Richardson, TX (US); Jeffrey Pulver, Great Neck, NY (US)

Correspondence Address: PILLSBURY WINTHROP SHAW PITTMAN, LLP, P.O. BOX 10500, MCLEAN, VA, 22102, US

(21) Appl. No.: 11/490,130

(22) Filed: Jul. 21, 2006

Related U.S. Application Data
(60) Provisional application No. 60/701,077, filed on Jul. 21, 2005.

(51) Int. Cl. H04L 9/00

(52) U.S. Cl. 713/156

(57) ABSTRACT

A system and method for enabling secure Voice over IP (VoIP) communication includes receiving a request for the generation of a certificate to be used in conjunction with a VoIP communication, generating a certificate in response to the request, the certificate being generated based, at least in part, on a voice sample of a user that made the request, and thereafter making the certificate available for use to enable secure VoIP communication. The system and method preferably leverages the session initiation protocol (SIP).

This application claims the benefit of U.S. Provisional Application No. 60/701,077, filed Jul. 21, 2005.

### BACKGROUND

1. Field of the Invention

Embodiments of the present invention are related to telecommunications. More particularly, embodiments of the present invention are related to systems and methods for improving IP communications such as Instant Messaging and voice over internet protocols (VoIP). This may include the use of Internet Technology to support legacy networks such as the circuit switched and the cellular/GSM networks.

2. Background of the Invention

Certificates are widely used today in Web servers and e-commerce servers. They are used for authentication, encryption and digital signatures. They have been shown to provide excellent security properties as shown by the wide use of secure web sites and e-commerce sites by both consumers and enterprises. However, widespread certificate usage in smaller Internet hosts such as PCs and laptops has not happened to date, despite the fact that these devices could use these same security services using certificates. The main reasons for this are:
1. Certificates are difficult to acquire, and the enrollment process is time-consuming
2. Certificates issued by commercial Certificate Authorities (CAs) are expensive, often costing hundreds of dollars per year
3. Certificates have been generally associated with hosts (devices) rather then users.

Attempts to simplify the enrollment and reduce the dependency on CAs have been made. For example, enterprises have acted as their own CA and issued certificates to users. However, these certificates have no validity outside the enterprise and as such have had little use. Schemes to do away with the CA entirely such as Pretty Good Privacy (PGP) where users sign each other's certificates has also been tried but has not achieved widespread adoption.

### SUMMARY OF THE INVENTION

Embodiments of the present invention build on methods developed in the IETF SACRED (Securely Available Credentials) and SIP (Session Initiation Protocol) Working Groups, the efforts of which are well-known. Embodiments utilize self-signed certificates but provides a secure method of storage and retrieval. The system and methodology described in this document introduces a novel Voice Recognition Server which combines with passcodes (usernames and passwords) to provide the highest level of security while overcoming the drawbacks listed earlier. As such, this approach should enable millions of VoIP devices (clients, phones, adapters, gateways, cell phones, WiFi phones, presence and instant messaging clients) to utilize certificates to provide end-to-end secured communications services at low cost. While the system and method are most efficient with SIP [SIP] VoIP endpoints, the system and method can also be used with other signaling protocols by using HTTPS or SACRED for credential/certificate operations and a Gateway for the Voice Recognition Server. Also introduced is a novel Certificate Factory that generates random self-signed credentials and certificates for users of the System. Note that certificates are normally generated and signed by a Certificate Authority (CA), or generated and signed by a user.

For example, certificates stored and retrieved using this system can be used for:
1. Secure Multipurpose Internet Mail Exchange (S/MIME) integrity of signaling and message bodies
2. S/MIME encryption of signaling and message bodies
3. S/MIME signing for authentication of messages and bodies
4. Establishment of secure media sessions, such as Secure Real-time Transport Protocol (SRTP) for encrypted and authenticated voice, video, text, and gaming sessions.
5. Authentication with Transport Layer Security (TLS) connections

### BRIEF DESCRIPTION OF THE DRAWINGS

FIG. 1 depicts components of an exemplary system in accordance with an embodiment of the present invention.

FIG. 2 depicts an enrollment process in accordance with an embodiment of the present invention.

FIG. 3 depicts a credential download process in accordance with an embodiment of the present invention.

FIG. 4 depicts a certificate download process in accordance with an embodiment of the present invention.

### DETAILED DESCRIPTION

Components of the System:

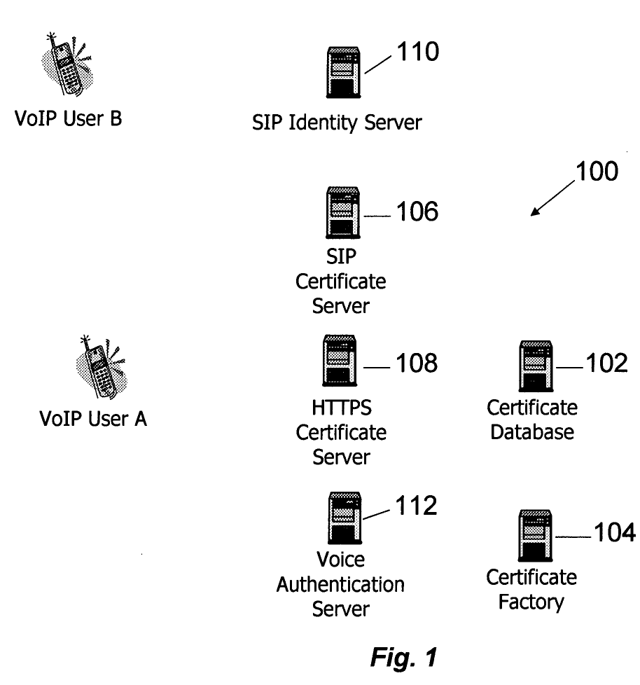

The main components of a system 100 in accordance with an embodiment of the present invention as shown in FIG. 1 are as follows.

Certificate Database 102—for storage of credentials and certificates. The credentials consist of the user's private key, while the certificate consists of the user's public key and identity, signed by a CA. The certificate can also be self signed. The credential can be encrypted by the user using a passcode known only to the user to provide the highest level of security.

Certificate Factory 104—used to generate self-signed or CA signed certificates. Users can either generate their own certificates or utilize this function to have one randomly generated for them upon enrollment.

SIP Certificate Server 106 [SIPCerts]—a SIP presence server used for uploading and retrieving credentials and certificates using SIP Events [SIPEvents] including the PUBLISH, SUBSCRIBE, and NOTIFY methods.

HTTPS Certificate Server 108—a secure web server used for uploading and retrieving credentials and certificates using GET/POST, or the SACRED protocol[SACRED]. The HTTPS Certificate Server 108 can be utilized by VoIP endpoints that either do not support SIP (such as H.323 or proprietary endpoints) or do not support SIP Events extensions (PUBLISH, SUBSCRIBE, NOTIFY).

SIP Identity Server 110—used to provide enhanced SIP identity [SIPIdentity] for certificate notifications.

Voice Authentication Server 112—used to perform voice print enrollment and authentication for credential download requests. The Voice Authentication Server 112 is capable of answering calls in SIP, and, through a Gateway, H.323 and PSTN calls. Even proprietary signaling protocols such as Skype could be used with an appropriate gateway as well as the PSTN and Cellular networks.

Operation of the System:

The system has three main modes of operation which will be described in the following sections. The first is Enrollment, when a new user establishes service, gets a credential and certificate. The second is Credential Download in which a user downloads a credential and certificate into one of his or her VoIP devices. The third is Certificate Download, in which any user downloads the public certificate of the user.

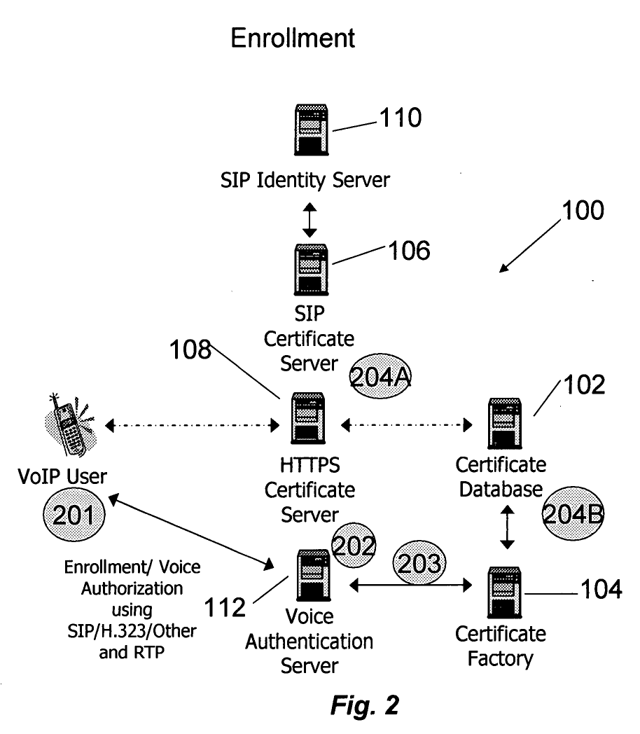

As shown in FIG. 2, Enrollment in the service for an endpoint that supports SIP and SIP Events comprises several steps.

At step 201, a VoIP endpoint wishing to obtain a certificate places a call (dials a phone number or SIP Uniform Resource Identifier (URI)). For highest security, a Secure SIP (sips) URI is used which allows the user to verify the certificate presented by the Voice Authentication Server 112 over the TLS connection.

At step 202, the Voice Authentication Server 112 authenticates the user using HTTP Digest (shared secret). This shared secret may be used for registration and authentication, or it may be a unique one for this service.

At step 203, the Voice Authentication Server 112 steps the user through the enrollment process including billing, etc. At step 203, the server also records voice samples to be used for authentication of future authentication of the user.

The user has the option of generating his own self signed certificate and credential (step 204A) or requesting the Service generate one for the user (step 204B). If the user requests the Service generate one, the Certificate Factory 104 generates a unique certificate and stores it in the Certificate Database 102. If the user wishes to upload his own, the user sends a SIP PUBLISH to the SIP Certificate Server 106 to upload the certificate, which stores the certificate in the Certificate Database 102.

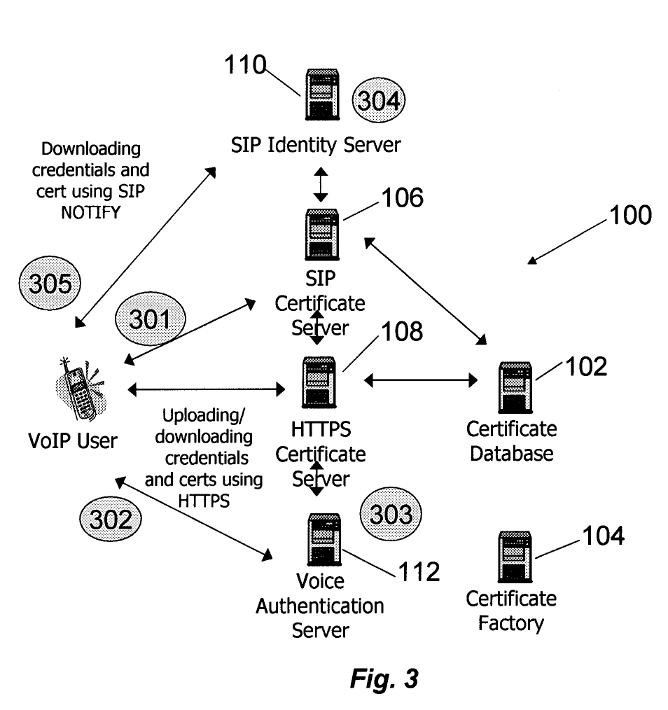

As shown in FIG. 3, Credential Download for a VoIP device that supports SIP Events comprises several steps.

At step 301, any VoIP endpoint under the control of the user sends a SUBSCRIBE to the SIP Certificate Server 106 and requests the credential. The SIP Certificate Server 106 authenticates the user using a shared secret (passcode), then places the subscription in a pending state.

At step 302, the user is directed to call the Voice Authentication Server 112 to complete the authentication process. This can be done using a SIP REFER [REFER], an instant message with a SIP URI, or some method.

At step 303, the user calls the Voice Authentication Server 112 and provides its shared secret key to authenticate. The Voice Authentication Server 112 then authenticates the user's voice against the stored voiceprints from the enrollment stage.

Once the user is fully authenticated, the subscription is authorized and, at step 304, SIP Certificate Server 106 generates a SIP NOTIFY which is routed through the SIP Identity Server 110, which signs the request and provides integrity protection over the certificate, then to the VoIP endpoint.

The VoIP endpoint installs the credential and certificate and is ready to establish secure sessions.

For a VoIP endpoint that supports SIP but not SIP Events, the enrollment is the same as before, but the only option is to have the Certificate Factory 104 generate the certificate. Downloading the certificate uses the following steps.

The VoIP endpoint, initiates a secure web session to the HTTPS Certificate Server 108 authenticates the user using a shared secret (passcode), then places the subscription in a pending state.

The user is directed to call the Voice Authentication Server 112 to complete the authentication process. This can be done by passing a SIP URI in a web page, sending a SIP REFER, an instant message with a SIP URI, or some method.

The user calls the Voice Authentication Server 112 and provides its shared secret to authenticate. The Voice Authentication Server then authenticates the user's voice against the stored voiceprints from the enrollment.

Once the user is fully authenticated, the HTTPS Certificate Server 108 pushes a web page which contains the credential and certificate. The VoIP endpoint installs the credential and certificate and is ready to establish secure sessions.

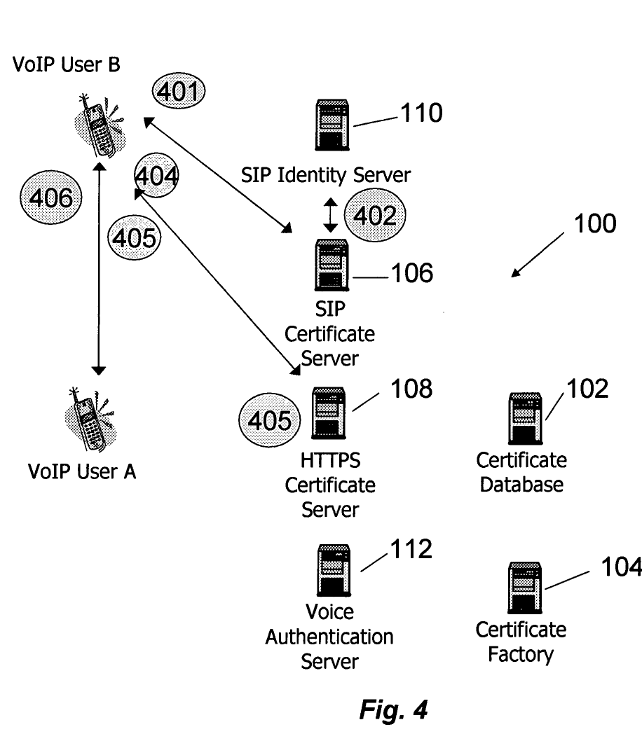

Certificate Download, as shown in FIG. 4, comprises the following steps when another user (User B) wishes to establish a secure session with User A, uses the Service to fetch the public certificate of the user prior to establishing the session.

If the endpoint supports SIP Events, a SUBSCRIBE is sent to the SIP Certificate Server 401. Since the public certificate is freely available to anyone who requests it, the SIP Certificate Server does not authenticate the requestor.

At step 402, a NOTIFY is sent with the certificate which is routed through the SIP Identity Server, which signs the message and provides integrity protection over the certificate.

The caller now can utilize the certificate to establish a secure session with the user.

If the user does not support SIP Events, the steps are as follows:

The user (User B) initiates a secure web session to the HTTPS Certificate Server 108 to request the public certificate (step 404).

The user validates the signature provided by the HTTPS Certificate Server to ensure that the certificate returned is the correct one (step 405).

The HTTPS Certificate Server then provides the certificate to the user which can then utilize the certificate to establish secure sessions with the user (step 406).

Note that this Service can be provided within a domain, in which case all the requests (SIP, HTTPS, etc.) are sent to the user's well known URI. The service can also be provided outside a domain, in which case requests are sent to a URI constructed based on the user's URI and the Service URI.

For example, if the user's URI is sips:user@example.com and the Service is provided by the example.net domain, a method of constructing the URI could be to escape the user's URI into the user part of the URI, e.g. sips:user%40example.com@example.net. HTTPS URIs could be generated as follows: https://certs.example.net/user%40example.com Other SIPS and HTTPS URI mapping conventions could be used.

Another variant on the system would be to leave out the voice recognition part for a lower level of security. In this case, the Voice Authentication Server 112 would just become an IVR for an automated enrollment system.

Another variant would use H.323 as the call signaling protocol for the VoIP endpoint. In this scenario, the HTTPS Certificate Server 108 would be used, and H.323 would just be used for the voiceprint validation.

Note that the same credential can be installed on multiple devices at the same time. The credentials and certificates can be synchronized using the SIP Events mechanism.

Another variant on the System is to use voiceprint certificates instead of X.509 certificates. The Service could then generate self-signed voiceprint certificates of users after enrollment and distribute them to users who could use them to verify the voice of the user they have established a session with.

The following references may provide additional useful background:

[SIP] Rosenberg, J., Schulzrinne, H., Camarillo, G., Johnston, A., Peterson, J., Sparks, R., Handley, M., and E. Schooler, “SIP: Session Initiation Protocol”, RFC 3261, June 2002.

[SIPEvents] Roach, A., “Session Initiation Protocol (SIP)-Specific Event Notification”, RFC 3265, June 2002.

[SIPCert] Jennings, C. and J. Peterson, “Certificate Management Service for SIP”, draft-ietf-sipping-certs-00 (work in progress), October 2004.

[SIPIdent] Peterson, J., “Enhancements for Authenticated Identity Management in the Session Initiation Protocol (SIP)”, draft-ietf-sip-identity-03 (work in progress), September 2004.

[SACRED] Gustafson, D., M. Just, M. Nystrom, “Securely Available Credentials (SACRED)—Credential Server Framework,” RFC3760, April 2004

[REFER] Sparks, R. “The SIP Refer Method,” RFC 3515.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method for enabling secure Voice over IP (VoIP) communication, comprising:
receiving a request for the generation of a certificate to be used in conjunction with a VoIP communication;
generating a certificate in response to the request, the certificate being generated based, at least in part, on a voice sample of a user that made the request; and
thereafter making the certificate available for use to enable secure VoIP communication.

2. The method of claim 1, further comprising sending a credential to the user.

3. The method of claim 2, further comprising authenticating the user's voice.

4. The method of claim 1, wherein Session Initiation Protocol (SIP) is used in making the certificate available for use.

5. The method of claim 1, further comprising employing a HTTPS server.

6. The method of claim 1, wherein the steps of receiving a request and generating a certificate are part of an enrolment process.

7. The method of claim 1, further comprising employing a certificate factory to generate the certificate.

8. The method of claim 1, further comprising allowing the user to supply a suer-generated certificate.

9. The method of claim 1, further comprising storing the certificate in a certificate database.

10. The method of claim 1, further comprising providing the certificate to a first user who intends to communicate with a second user, wherein the first user obtains the certificate of the second user.
